(19) United States
(12) Patent Application Publication
(10) Pub. No.: US 2026/0223834 A1
(43) Pub. Date: Aug. 6, 2026

(54) TREE STAND WITH SEAT SHELF

(71) Applicant: Double Dragon International, Inc., Dubuque, IA (US)

(72) Inventor: Randy L. Schofield, Humbird, WI (US)

(73) Assignee: Double Dragon International, Inc., Dubuque, IA (US)

(21) Appl. No.: 19/576,375

(22) Filed: Mar. 24, 2026

Related U.S. Application Data
(63) Continuation-in-part of application No. 17/839,052, filed on Jun. 13, 2022.

(51) Int. Cl. A01M 31/02; A45F 4/00

(52) U.S. Cl. CPC A01M 31/02; A45F 4/00; A45F 2004/006

(57) ABSTRACT

A tree stand includes a platform, a post pivotably connected to the platform, a leveling tab extending from the post, and a shelf tab extending from the post. The post is pivotable between an upright position relative to the platform and a folded position along the platform. The seat is pivotably connected to the post and is pivotable between a seat position projecting from a first side of the post and a shelf position projecting from a second side of the post opposite the first side. The seat is supported from below by the leveling tab in the seat position and vertically hangs from the shelf tab in the shelf position.

### CROSS-REFERENCE TO RELATED PATENT APPLICATIONS

The present application claims the benefit of and is a continuation-in-part of U.S. Patent Application No.17/839052 filed on June 13, 2022 by Randy L. Schofield and entitled TREE STAND WITH SEAT LEVELING SHELF LOCK, the full disclosure of which is hereby incorporated by reference.

### BACKGROUND

Tree stands typically include a platform upon which a person may stand. Some tree stands additionally include a secondary platform that serves as a seat. As such tree stands are often used in remote areas, transporting such tree stands and other gear is often difficult.

### BRIEF DESCRIPTION OF THE DRAWINGS

FIG. 1 is a side view schematically illustrating portions of an example tree stand supported by a tree and having a seat in a seat position.

Figure is a side view schematically illustrating portions of the example tree stand of FIG. 1 in a folded state while being transported by a person with the seat in a shelf position.

FIG. 3 is a flow diagram of an example method for transporting a tree stand.

FIG. 4 is a perspective view of an example tree stand having a seat in a seat position.

FIG. 5 is an enlarged perspective view of a portion of the tree stand of FIG. 4.

FIG. 6 is a side of the tree stand of FIG. 4 with the seat supported in a first seat position.

FIG. 7 is side view of the tree stand FIG. 4 with the seat supported in a second seat position.

FIG. 8 is a perspective view of the example tree stand of FIG. 4 in a folded state with the seat in a shelf position.

FIG. 9 is an enlarged perspective view illustrating portions of the example tree stand of FIG. 8.

FIG. 10 is a side view of the example tree stand of FIG. 4 in the folded state while being transported by a person with articles supported on the seat in the shelf position.

FIG. 11 is a side view schematically illustrating portions of an example tree stand supported by a tree and having a seat in a first seat position.

FIG. 12 is a side view schematically illustrating portions of the example tree stand of FIG. 11 supported by the tree and having the seat in a second seat position.

FIG. 13 is a side view schematically illustrating portions of the example tree stand of FIG. 11 in a folded state while being transported by a person with the seat in a shelf position.

FIG. 14 is a perspective view of an example tree stand having a seat in a seat position at a first tilt angle.

FIG. 15 is a perspective view of the example tree stand of FIG. 14 with the seat in the seat position at a second tilt angle.

FIG. 16 is an enlarged fragmentary perspective view of a portion of the tree stand of FIG. 15.

FIG. 17 is an enlarged fragmentary perspective view of a portion of the tree stand of FIG. 15.

FIG. 18 is a perspective view of the example tree stand of FIG. 14 and a folded state with the seat in a shelf position.

FIG. 19 is an enlarged fragmentary perspective view of a portion of the tree stand of FIG. 18 prior to engagement of an example SLSC with an example shelf tab.

FIG. 20 is an enlarged fragmentary perspective view of a portion of the tree stand of FIG. 18 illustrating engagement of the example SLSC with the example shelf tab.

FIG. 21 is a schematic diagram illustrating portions of an example tree stand having an example seat in a seat position.

FIG. 22 is a schematic diagram illustrating portions of the example tree stand of FIG. 21 with the example seat in a shelf position.

FIG. 23 is a side view schematically illustrating portions of an example tree stand supported by a tree and having a seat in a first seat position.

FIG. 24 is a side view schematically illustrating portions of the example tree stand of FIG. 11 in a folded state while being transported by a person with the seat in a shelf position.

FIG. 25 is an enlarged fragmentary perspective view illustrating portions of an example tree stand with an example seat in a seat position.

FIG. 26 is an enlarged fragmentary perspective view illustrating portions of the example tree stand of FIG. 25 with the example seat in a shelf position.

FIG. 27 is an enlarged fragmentary perspective view illustrating portions of an example tree stand with an example seat in a seat position.

FIG. 28 is an enlarged fragmentary perspective view illustrating portions of the example tree stand of FIG. 27 with the example seat in a shelf position.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example tree stands that facilitate easier transport of the tree stand and additional gear. The example tree stands are collapsible or foldable to a state where the tree stand may be carried along a person’s back using shoulder straps, similar to a backpack. The example tree stands are foldable in a fashion such that the seat of the tree stand may serve as a shelf for supporting the additional gear when the tree stand is folded and carried along the person’s back. In some implementations, the seat is pivotable by at least 180 degrees between a seat position and a shelf position. The example tree stands comprise a combined dual-purpose seat leveler-suspension coupler in the form of a seat leveling shelf lock that engages a leveling tab to establish the orientation of the seat when the tree stand is in use and that engages a shelf tab to retain the seat in the shelf position when the tree stand is folded for transport.

Disclosed is an example tree stand that comprises a platform, a post pivotable between an upright position relative to the platform and a folded position along the platform, a seat pivotable between a seat position and a shelf position, a leveling tab extending from the post, a shelf tab extending from the post, and a seat leveling shelf lock movably connected to and projecting from the seat. The seat is pivotable between a seat position in which the seat leveling shelf lock engages the leveling tab to establish an angle of the seat relative to the post in the seat position while the post is in the upright position and a shelf position in which the seat leveling shelf lock engages the shelf tab to retain the seat in the shelf position while the post is in the folded position.

In some implementations, the leveling tab and the shelf tab extend from opposite sides of the post and wherein the leveling tab is offset relative to shelf along a longitudinal axis of the post. In some implementations, the leveling tab, the shelf tab, and the post are integrally formed as a single unitary body. In some implementations, the leveling tab, the shelf tab, and/or the post are cast from aluminum as a single unitary body.

In some implementations, the seat leveling shelf lock is removable from the seat. In some implementations, the seat leveling shelf lock extends through the shelf tab while the post is in the folded position. In some implementations, the seat comprises an internally threaded bore and wherein the seat leveling shelf lock comprises an external thread, the seat leveling shelf lock being threaded through the internally threaded bore and being translatable by rotation of the seat leveling shelf lock relative to the seat. In some implementations, the seat leveling shelf lock extends through the shelf tab while the post is in the folded position.

In some implementations, the combined dual-purpose seat leveling- suspension coupler is in the form of a seat leveling shelf lock comprising shaft that is threaded through the seat to bear against the leveling tab to facilitate adjustment of the angle at which the seat extends from the post. In such implementations, the shaft has an end that is angled or bent so as to be rotatable such at the end engages the shelf tab to suspend or vertically hang the seat from below shelf tab in the shelf position. In some implementations, the shelf tab includes an opening, such as a slot or bore through which the end passes when the seat is rotated or pivoted to the shelf position, wherein rotation of the end results in the end engaging a face of the seat to suspend or hang the seat in the shelf position. In other implementations, the end is located so as to extend along a transverse side of the seat, not extending through any opening or slot in the seat, wherein rotation of the end results in the end engaging a face of the sea to suspend or hang the seat in the shelf position.

In some implementations, the combined dual-purpose seat leveling-suspension coupler is pivotally or rotatably supported or coupled to the seat and having an adjustable length. The dual-purpose seat leveling-suspension coupler rotates to a first leveling tab engaging position at which a hook or foot of the dual-purpose seat leveling-suspension coupler bears against or engages the leveling tab to support the seat and a user selectable height above the leveling tab and at a user selectable angle relative to the post. The dual-purpose seat leveling-suspension coupler has an adjustable length to adjust the angle at which the seat is supported relative to the post and above an underlying platform.

In some implementations, the seat leveling-suspension coupler comprises a screw adjustable support member having mating internal and external threads, wherein rotation linearly translates portions of the coupler to adjust its length. In such implementations, the coupler may comprise a single threaded interface, a threaded shaft received within a threaded bore. In some implementations, the seat leveling-suspension coupler may comprise two threaded interfaces, two threaded end fittings with opposing thread directions in a central body that rotates to change the overall length (similar to a turnbuckle).

The combined dual-purpose seat leveler-suspension coupler rotates to a second shelf tab engaging position where the foot/hook engages a face or other portions of the shelf tab to suspend the seat or vertically hang the seat from the shelf tab when the seat is in the shelf position. In such implementations, the length of the coupler may be adjusted to tighten enhanced securement of the hook/foot to the shelf tab.

In some implementations, this tree stand comprises separate components to support the seat in the seat position and to support the shelf position. In such implementations, the tree stand may comprise a seat leveler and a separate suspension coupler. The seat leveler extends from either the seat or the leveling tab and has an adjustable length to adjust the angle at which the seat extends from the post (the tilt of the seat away from the post). In some implementations, the seat leveler may comprise a threaded shaft which is threaded through or into a threaded bore in the seat and/or leveling tab, wherein rotation of the shaft adjust a length of the shaft extending between the leveling tab and the seat to adjust an angle of the seat. In some implementations, the seat leveler may comprise a leg extending from one of the seat and the leveling tab and having a foot or hook which bears against a face of the other of the and leveling tab, wherein the arm has an adjustable length.

In some implementations, the suspension coupler extends from and the shelf tab, wherein the suspension coupler spaces and supports the seat over and above the shelf when the seat is in the shelf position. The suspension coupler suspends or vertically hangs the seat in a cantilevered state from the post, below and outwardly beyond the shelf tab. In some implementations, the suspension coupler comprise an arm having a foot or hook which bears against or engages a face of the seat (such as a lower face of the seat) when the seat is in the shelf position. In some implementations, the suspension a shaft having a bent end, wherein the shaft is rotatably supported by one of the seat and the shelf tab such that rotation of the shaft rotates the bent end to a position at which the bent end bears against or engages a face of the seat (such as a lower face of the seat) when the seat is in the shelf position to vertically hang the seat from the shelf tab in the shelf position.

In some implementations, the tree stand further comprises a shoulder strap connectable to at least one of the platform and the post when the post is in the folded position and while the seat is in the shelf position.

Disclosed is an example method for transporting a tree stand. The example method comprises pivoting a post of the tree stand from an upright position to a folded position along the platform, pivoting a seat of the tree stand from a seat position on a first side of the post overhanging the platform to a shelf position on a second side of the post opposite the first side, engaging a leveling tab projecting from the post with a seat leveling shelf lock projecting from the seat with the seat in the seat position, and engaging a shelf tab projecting from the post with the seat leveling shelf lock projecting from the seat with the seat in the shelf position. In some implementations, the method may further comprise threading the seat leveling shelf lock through the seat into engagement with the leveling tab when the seat is in the seat position and threading the seat leveling shelf lock through the seat while the seat leveling shelf lock is engaged to the shelf tab to retain the seat in the shelf position.

For purposes of this disclosure, the recitation that the seat “vertically hangs from” the shelf tab means that the seat is suspended straight down from the shelf tab, in a direction perpendicular to the ground (at a 90° angle to the horizon) (similar to a plumb line).

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature.

For purposes of this disclosure, the phrase “configured to” denotes an actual state of configuration that fundamentally ties the stated function/use to the physical characteristics of the feature proceeding the phrase “configured to”.

For purposes of this disclosure, the term “releasably” or “removably” with respect to an attachment or coupling of two structures means that the two structures may be repeatedly connected and disconnected to and from one another without material damage to either of the two structures or their functioning.

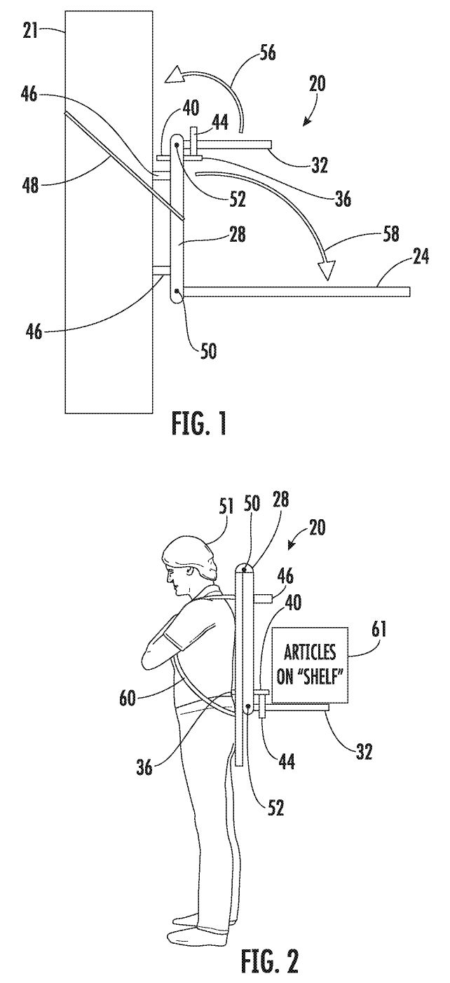

FIG. 1 is a diagram schematically illustrating portions of an example tree stand 20 mounted along a trunk 21 of an example tree. Tree stand 20 facilitates easier transport of the tree stand and additional gear. Tree stand 20 is collapsible or foldable to a state such that the tree stand may be carried along a person’s back using shoulder straps, similar to a backpack. Tree stand 20 is foldable in a fashion such that the seat of the tree stand may serve as a shelf for supporting the additional gear when the tree stand is folded and carried along the person’s back. Tree stand 20 utilizes a dual-purpose seat leveling shelf lock that controls the orientation of the seat to accommodate personal preferences or to accommodate mounting of the stand to non-vertical portions of the tree. The dual-purpose seat leveling shelf lock further locks or retains the seat in a shelf position or orientation when the tree stand is folded and being transported. Tree stand 20 comprises platform 24, post 28, seat 32, leveling tab 36, shelf tab 40 and seat leveling shelf lock 44.

Platform 24 comprises a panel or other structure upon which a person residing on tree stand 20 may stand and/or rest his or her feet. In some implementations, platform 24 may comprise an open grill or framework. In some implementations, platform 24 may comprise an imperforate panel. Platform 24 is supported by post 28.

Post 28 comprise an elongate structure that spaces and supports platform 24 and seat 32 along the example trunk 21. In some implementations, post 28 additionally supports claw structures 46 that extend between post 28 in the sides of trunk 21. In some implementations, post 28 is further secured to trunk 21 by a strap or cord 48 that wraps about trunk 21. Post 28 is pivotably connected to platform 24 for pivoting movement about axis 50 such that post 28 may pivot between the upright position relative to platform 24 and shown in FIG. 1 and a folded position (shown in FIG. 2).

Seat 32 comprises a platform upon which a person may be seated. Seat 32 is supported by post 28 so as to overhanging extend above platform 24 when seat 32 is in the seat position shown in FIG. 1. Seat 32 is pivotably coupled to post 28 for pivotal movement about axis 52 such that seat 32 may pivot from the seat position shown in FIG. 1 to a shelf position as shown in FIG. 2.

Leveling tab 36 comprises a projection that extends from post 28 below pivot axis 52 (when seat 32 is oriented above platform 24 in the seat position). Leveling tab 36 is sized and located so as to be engageable by seat leveling shelf lock 44 when seat 32 is in the seat position shown in FIG. 1. In some implementations, tab 36 is integrally formed as a single unitary body with post 28. In some implementations, tab 36 is removably or fixedly mounted to post 28.

Shelf tab 40 comprises a projection that extends from post 28 on an opposite side of post as leveling tab 36. Shelf tab 40 is sized and located so as to be engageable by seat leveling shelf lock 44 when seat 32 is in the shelf position shown in FIG. 2. In some implementations, shelf tab 40 is integrally formed as a single unitary body with post 28. In some implementations, shelf tab 40 is removably or fixedly mounted to post 28.

Seat leveling shelf lock 44 comprises structure that is movably connected to and projects from seat 32. Lock 44 may be moved relative to seat 32 to adjust the length of lock 44 extending between leveling tab 36 and seat 32 to affect the angular positioning of seat 32 and to retain seat 32 in a selected angular position (about axis 52). For example, in some implementations, seat 32 may be retained in an orientation perpendicular to the longitudinal axis of post 28 (such as when trunk 21 does not extend at an angle). In some implementations, lock 44 may cooperate with tab 36 to retain seat 32 in a downwardly tilted orientation or an upwardly tilted orientation to accommodate the preferences of the person using seat 32. In some implementations, lock 44 may cooperate with tab 36 retain seat in a downwardly tilted orientation relative to post 28 or an upwardly tilted orientation relative to post 28 such that seat 32 is horizontal despite post 28 being tilted due to trunk 21 being tilted (not perpendicular to the horizon).

FIG. 2 illustrates tree stand 20 in a collapsed or folded state while being worn by a person 51. To move tree stand 20 from the in-use state shown in FIG. 1 to the collapsed or folded state shown in FIG. 2, seat 32 is pivoted about axis 52 in the direction indicated by arrow 56 shown in FIG. 1. Seat 32 is pivoted to a position such that lock 44 may engage shelf tab 40. In some implementations, lock 44 snaps or otherwise releasably connect to shelf lock 44 to retain in the shelf position shown in FIG. 2. In some implementations, lock 44 may be screwed or threaded into a threaded bore provided in shelf tab 40. In some implementations, lock 44 may be passed through a bore in shelf tab 40, wherein lock 44 is secured by a nut threaded onto the end of the lock 44 (configured as a bolt). In some implementations, lock 44 may be detached from seat 32 and reconnected, joining shelf tab 40 and seat 32 when or after seat 32 has been pivoted to overlie shelf tab 40. In some implementations, lock 44 comprises a threaded bolt which may be unscrewed or unthreaded from seat 32 and which is threaded in an upward direction (as seen in FIG. 1) through shelf tab 40 and upwards into a threaded bore provided in seat 32 or threaded into a nut provided on a top side of seat 32 while seat 32 overlies shelf tab 40.

To further move tree stand 20 to the collapsed or folded state, post 28 is pivoted about axis 50 in the direction indicated by arrow 58 shown in FIG. 1. This results in post 28 being close to parallel or parallel with platform 24. In some implementations, platform 24 is provided with openings for receiving portions of stand 20 which would otherwise inhibit post 28 from lying in close proximity and parallel or near parallel to platform 24. For example, platform 24 may include an opening to receive leveling tab 36 when post 28 is pivoted to the folded position shown in FIG. 2.

As shown by FIG. 2, when tree stand 20 is in the collapsed or folded state, platform 24 forms a back backing, wherein post 28 extends substantially down the center of platform 24 and wherein seat 32 projects outwardly from post 28 and from platform 24 to serve as a shelf. As shown by FIG. 2, tree stand 20 may additionally include a shoulder strap 60 connectable at opposite ends to at least one of platform 24 and/or post 28 to facilitate carrying of tree stand 20 in a fashion similar to a backpack. As shown by FIG. 2, articles 61 may rest upon seat 32. In some implementations, additional securement mechanisms may be provided on seat 32, such as cleats, projections, or the like, to facilitate securement of such articles on the shelf provided by seat 32 with bungee cords, straps or the like.

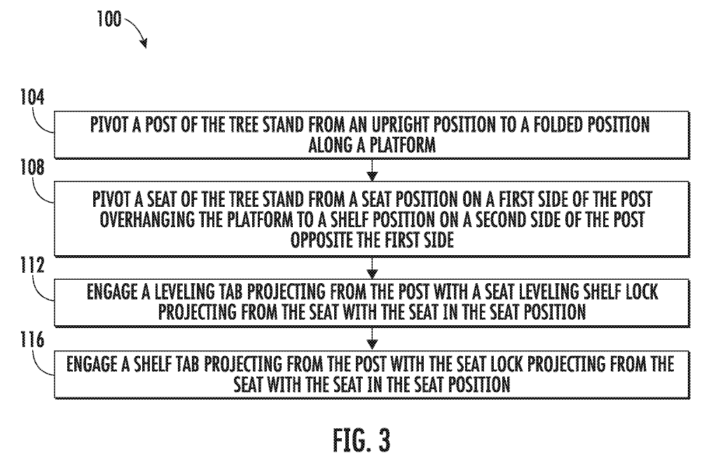

FIG. 3 is a flow diagram of an example method 100 for transporting a tree stand, such as tree stand 20. Although method 100 is described in the context of being carried out with tree stand 20, method 100 may likewise be carried out with any of the following later described tree stands or with similar tree stands. As indicated by block 104, a post of a tree stand is pivoted from an upright position to a folded position along a platform. As discussed above with respect to tree stand 20, post 28 is pivoted from the upright position shown in FIG. 1 to the folded position along platform 24 as shown in FIG. 2.

As indicated by block 108, a seat of the tree stand is pivoted from a seat position on a first side of the post overhanging the platform to a shelf position on a second side of the post opposite the first side. As discussed above with respect to tree stand 20, seat 32 is pivoted about axis 52 from a seat position shown in FIG. 1 on a first side of the post 28, overhanging the platform 24, to a shelf position on a second side of post 28 opposite the first side as seen in FIG. 2.

As indicated by block 112, a leveling tab projecting from the post is engaged with a seat leveling shelf lock projecting from the seat with a seat in the seat position. As discussed above with respect to tree stand 20, leveling tab 40 is engaged with seat leveling shelf lock projecting from the seat 32 with the seat 32 in the seat position shown in FIG. 1. In some implementations, seat leveling shelf lock 44 has a lower surface that simply rests (under the force of gravity) upon the top surface of leveling tab 36. In some implementations lock 44 may include a nut threaded onto a bolt, wherein the nut rests upon the top surface of leveling tab 36. In some implementations, seat leveling shelf lock 44 may engage seat 32 in other fashions. For example, seat leveling shelf lock 44 may be threaded into a threaded bore provided in leveling tab 36. In some implementations, seat leveling shelf lock 44 may be threaded through seat 32, wherein rotation of lock 44 linearly translates lock 44 to adjust an extent of lock 44 projecting below seat 32 and into engagement with leveling tab 36 so as to adjust the orientation of seat 32.

As indicated by block 116, the shelf tab projecting from the post is engaged with the seat leveling shelf lock projecting from the seat with the seat in the shelf position. As discussed above with respect to tree stand 20, shelf tab 40, projecting from post 28, is engaged with the seat leveling shelf lock 44 projecting from the seat 32 with the seat in the shelf position as shown in FIG. 2. As discussed above, in some implementations, lock 44 snaps or otherwise releasably connects to shelf lock 44 to retain in the shelf position shown in FIG. 2. In some implementations, lock 44 may be screwed or threaded into a threaded bore provided in shelf tab 40. In some implementations, lock 44 may be passed through a bore in shelf tab 40, wherein lock 44 is secured by a nut threaded onto the end of the lock 44 (configured as a bolt with the nut). In some implementations, lock 44 may be detached from seat 32 and reconnected, joining shelf tab 40 and seat 32 when or after seat 32 has been pivoted to overlie shelf tab 40. In some implementations, lock 44 comprises a threaded bolt which may be unscrewed or unthreaded from seat 32 and which is threaded in an upward direction (as seen in FIG. 1) through shelf tab 40 and upwards into a threaded bore provided in seat 32 or threaded into a nut provided on a top side of seat 32 while seat 32 overlies shelf tab 40.

FIG. 4 is a front perspective view of an example tree stand 220 in an in-use state, a state during which tree stand 20 may be positioned against or along a tree. As described above, tree stand 220 facilitates easier transport of the tree stand and additional gear. Tree stand 220 is collapsible or foldable to a state such that the tree stand may be carried along a person’s back using shoulder straps, similar to a backpack. Tree stand 220 is foldable in a fashion such that the seat of the tree stand may serve as a shelf for supporting the additional gear when the tree stand is folded and carried along the person’s back. Tree stand 220 utilizes a dual-purpose seat leveling shelf lock that controls the orientation of the seat to accommodate personal preferences or to accommodate mounting of the stand to non-vertical (tilted) portions of the tree. The dual-purpose seat leveling shelf lock further locks or retains the seat in a shelf position or orientation when the tree stand is folded and being transported. Tree stand 220 comprises platform 224, post 228, strut cables 230, seat 232, leveling tab 236, shelf tab 240, and seat leveling shelf lock 244.

Platform 224 comprises a panel or other structure upon which a person residing on tree stand 220 may stand and/or rest his or her feet. In the example illustrated, platform 224 comprises platform portion 300, claw portion 302 and post mounting ears 304. Platform portion 300 comprises an open grill or framework. In other implementations, platform 24 may comprise an imperforate panel or an imperforate panel having openings for receiving projections extending from post 228 when post 228 is folded against platform 224.

Claw portion 302 is provided on a front side of platform portion 300 and is configured to engage and grip the sides of a tree. In the example illustrated, claw portion 302 comprises a pair of diverging and angled toothed edges 308 that form an opening therebetween for receiving portions of a tree. In some implementations, claw portion 302 may be omitted, wherein other separate claws are provided along post to 28.

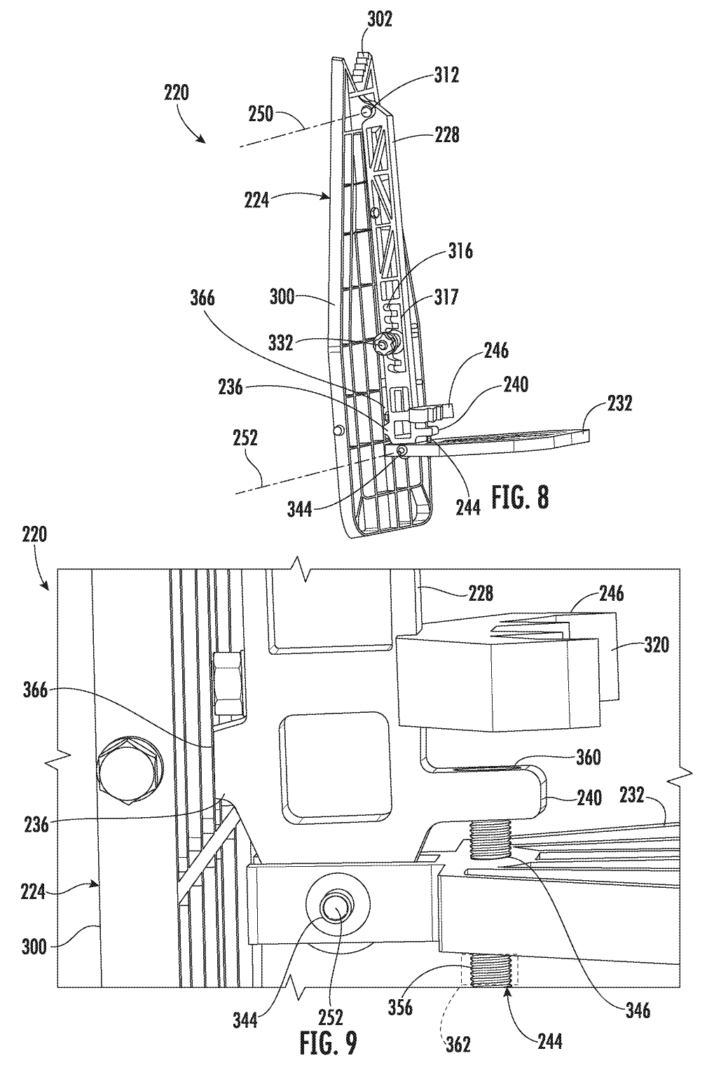

Post-mounting ears 304 project upwardly from a top surface of platform portion 300 proximate to claw portion 302. Post-mounting ears 304 receive post 228 and include a pair of aligned apertures through which a fastener 310 may extend, wherein the fastener 310 further extends through portions of post 228 to pivotally support post 228 for pivotable movement about a pivot axis 250 between the upright position shown in FIG. 4 and the folded position shown in FIG. 8.

Post 228 comprises an elongate structure that spaces and supports platform 224 and seat 232 along the example trunk 21 (shown in FIG. 1). In the example illustrated, post 228 additionally supports claw structure 246, cleats 314 and strut securement slots 316. Claw structure 246 is similar to claw portion 302 in that claw structure 246 is configured to extend between post 28 and the sides of trunk 21. Like claw portion 302, claw structure 246 comprises a toothed face 320 for gripping the sides of a tree. In the example illustrated, claw structure 246 is fastened to post 228 by a fastener 322. In other implementations, claw structure 246 may be integrally formed as part of a single unitary body with post 228.

Cleats 314 project from a side of post 228 opposite to that of toothed face 320. Cleats 314 each include a narrower neck 326 and a wider head portion 328. Cleats 314 are configured to secure a strap or cord, such as cord 48 (shown in FIG. 1) to post 228. As shown in FIG. 1, the cord 48 wraps about trunk 21.

Strut securement slots 316 comprise a series of vertically arranged slots that are angled in a downward direction towards a rear of platform portion 300. A vertical channel 317 extends along the ends of each of slots 316. Each of slots 316 is configured to receive the cylindrical portion of a fastener 332 which is secured to strut cables 230. Fastener 332 may be moved along channel 317 and selectively positioned within one of the slots 316 to adjust the location at which the ends of strut cables 230 are connected to post 228. Slots 316 facilitate adjustment of an angle at which platform 224 extends from post 228. As result, the angle of platform 224 may be adjusted to accommodate a person’s individual preferences or to accommodate the circumstances where post 228 is secured along a portion of a tree that is non-vertical, that may be tilted. In some implementations, when post 228 is mounted on a tilted portion of tree, platform 224 and seat 232 may be adjusted so as to both obliquely project from post 228 such that both platform 224 and seat 32 are substantially horizontal, parallel to the horizon, despite the tilt of the tree. In other implementations, strut cables 230 may be selectively positionable along and mountable to post to 28 using other mechanisms. In some implementations, slots 316 may be omitted, where the end of strut cables 230 are fixedly secured at one location along post 228.

Struct cables 230 extend at an angle between post 228 and platform portion 300 of platform 224. Strut cables 230 support platform portion 300 relative to post 228. As discussed above, the location at which the ends of strut cables 230 are secured to post 228 may be adjusted to adjust the relative angle between platform portion 300 and post 228. In some implementations, the angle may alternatively be adjusted by adjusting the length of strut cables 230 and/or the location which strut cables 230 are attached to platform portion 300. In some implementations, the angle between platform portion 300 and post 228 may not be adjustable.

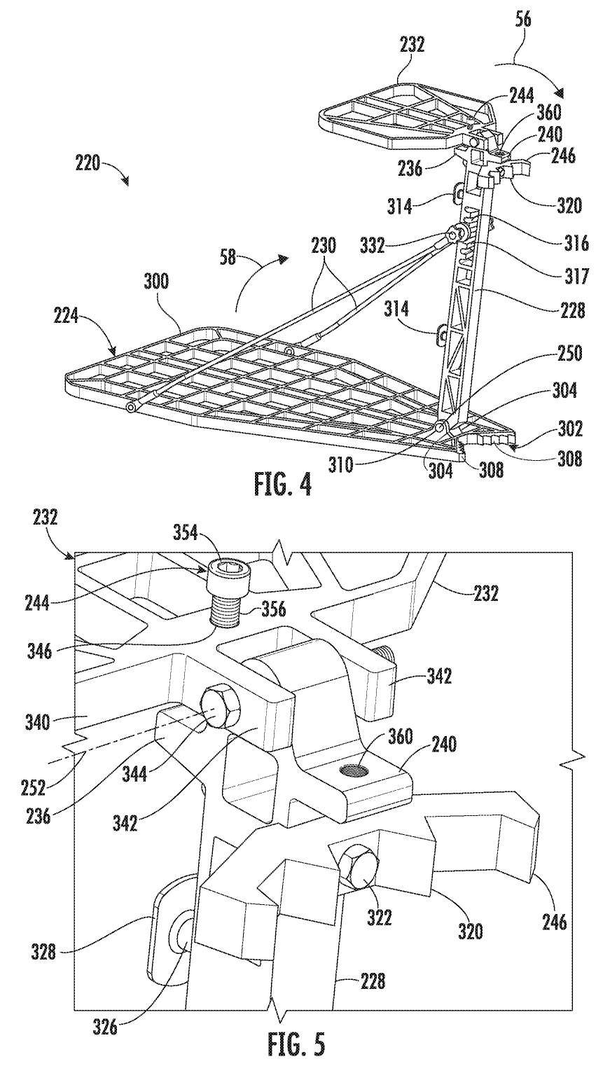

Seat 232 comprises a platform upon which a person may be seated. Seat 232 is supported by post 228 so as to overhang and extend above platform 224 when seat 232 is in the seat position shown in FIG. 4. As shown by FIG. 5, seat 232 comprises a seat portion 340 and a pair of forwardly extending prongs 342 which are spaced to receive a top portion of post 228 therebetween. Fastener 344 (in the form of a bolt) passes through a pair of aligned openings in prongs 342 and through an aligned opening through the top of post 228 to pivotably support seat 232 for the pivoting of seat 232 relative to post 228 about axis 252. Seat 232 may pivot from the seat position shown in FIG. 4 to a shelf position as shown in FIG. 8. In the example illustrated, seat 232 is pivotable by at least 180 degrees about pivot axis 252 between the seat position and the shelf position.

Leveling tab 236 comprises a projection that extends from post 228 below pivot axis 252 (when seat 232 is oriented above platform 224 in the seat position). Leveling tab 236 is sized and located so as to be engageable by seat leveling shelf lock 244 when seat 232 is in the seat position shown in FIG. 4. In the example illustrated, tab 236 is integrally formed as a single unitary body with post 228. In some implementations, tab 236 is removably or fixedly mounted to post 228.

Shelf tab 240 comprises a projection that extends from post 228 on an opposite side of post as leveling tab 236. Shelf tab 240 is sized and located so as to be engageable by seat leveling shelf lock 244 when seat 232 is in the shelf position shown in FIG. 8. In some implementations, shelf tab 240 is integrally formed as a single unitary body with post 228. In some implementations, shelf tab 240 is removably or fixedly mounted to post 228.

Seat leveling shelf lock 244 comprises structure that is movably connected to and projects from seat 232. Lock 244 may be moved relative to seat 232 to adjust the length of lock 244 extending between leveling tab 236 and seat 232 to affect the angular positioning of seat 232 and to retain seat 232 in a selected angular position (about axis 52). For example, in some implementations, seat 232 may be retained in an orientation perpendicular to the longitudinal axis of post 228 such as when trunk 21 does not extend at an angle). In some implementations, lock 244 may cooperate with tab 236 to retain seat 232 in a downwardly tilted orientation or an upwardly tilted orientation to accommodate the preferences of the person using seat 232. In some implementations, lock 244 may cooperate with tab 236 retain seat in a downwardly tilted orientation relative to post 228 or an upwardly tilted orientation relative to post 228 such that seat 232 is horizontal despite post 228 being tilted due to trunk 21 being tilted (not perpendicular to the horizon).

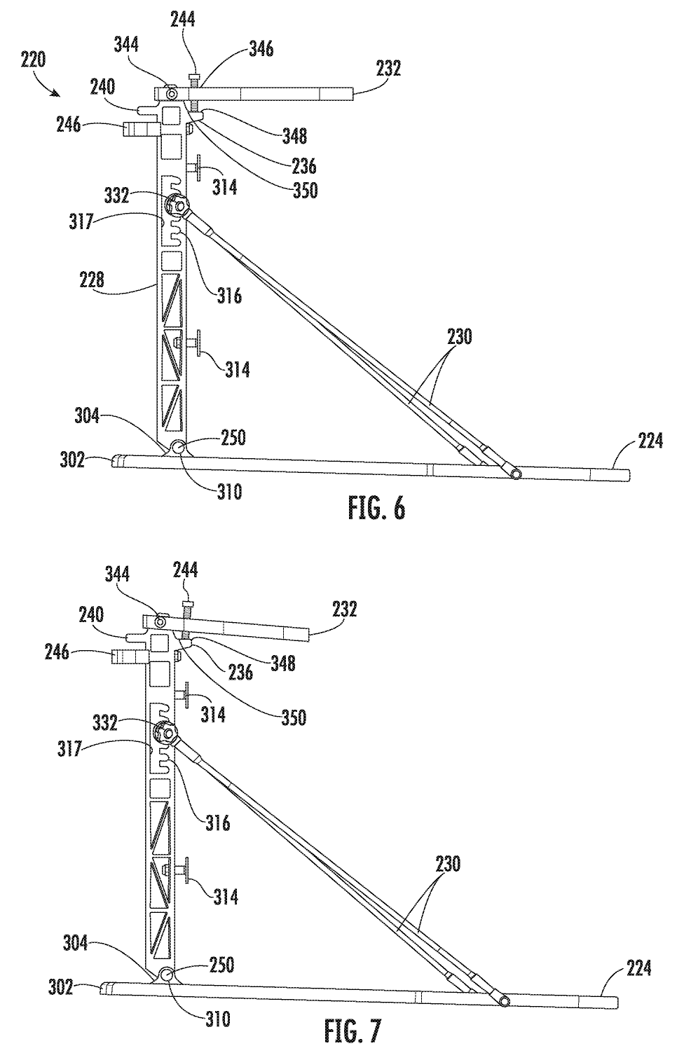

FIGS. 6 and 7 illustrate lock 244 cooperating with shelf tab 236 to support seat 232 at two different angles relative to the longitudinal axis of post 228. FIG. 6 illustrates lock 244 engaging tab 236 to support seat 232 at a 90-degree angle relative to the longitudinal axis of post 228. Such an angle may be beneficial in circumstances where post 228 is secured along a vertical portion of a tree, one that is perpendicular to the horizon. FIG. 7 illustrates lock 244 engaging tab 236 to support seat 232 at an oblique downwardly tilted angle relative to the longitudinal axis of post 228. Such an angle may be beneficial in circumstances where the person using tree stand 220 prefers a downwardly angled seat, one that is downwardly angle relative to the horizon. Such an angle may also be beneficial in circumstances where post 228 is secured along a tilted portion of the tree, such as a portion of the tree that tilts upwardly to the left (as seen in FIG. 7), wherein seat 232 is tilted downwardly to the right (as seen in FIG. 7) such that seat 232 is horizontal, parallel to the horizon.

In the example illustrated, lock 244 comprises a fastener in the form of a threaded bolt. Seat 232 comprises an internally threaded bore 346 having a centerline located so as to intersect leveling tab 236 when seat 232 is in the seat position. Lock 244 is threaded through the internally threaded bore 346 until its lower axial end 348 rests upon or abuts the top surface 350 of leveling tab 236. The established distance between the top surface 350 of tab 236 and seat 232 (and the corresponding angular positioning of seat 232 relative to post 228) may be adjusted by rotating lock 244.

In other implementations, the lower end of lock 244 may be turned or threaded into an internally threaded bore formed in tab 236. In some implementations, lock 244 may pass into or through an unthreaded bore or opening in leveling tab 236 and may be threaded through a nut above and resting upon leveling tab 236, wherein the positioning of the nut along the bolt may be adjusted to adjust the levelness of seat 232. In other implementations, other fasteners may be used to adjust the levelness or angle of seat 232 relative to post 228.

FIG. 8 illustrates tree stand 220 in a collapsed or folded state. To move tree stand 220 from the in-use state shown in FIG. 4 to the collapsed or folded state shown in FIG. 8, seat 232 is pivoted about axis 252 in the direction indicated by arrow 56 shown in FIG. 4. Seat 32 is pivoted to a position such that lock 244 may engage shelf tab 240.

As shown by FIG. 9, in the example illustrated where lock 244 is in the form of a threaded bolt having a head 354 and a threaded shaft portion 356 (shown FIG. 5). Lock 244 engages seat 232 by locating the head 354 of the bolt within a countersunk aperture 360 formed in shelf tab 240 and by threading the threaded shaft portion 356 into the internally threaded bore 346 in seat 232. Seat 232 may be pivoted about axis 252 to raise the head 354 out of the countersunk aperture 360 to provide access to head 354 for rotating lock 244. At the selected position, head 354 may be once again lowered into the countersunk aperture 360, suspending seat 232 at the selected angle. In some implementations, in lieu of head 354 having an Allen wrench interface, head 354 may comprise a polygonal (hex) outer circumferential side for rotation of lock 244.

As shown in broken lines, in some implementations, tree stand 220 may additionally comprise a nut 362, such as a lock nut, threaded onto shaft portion 356 below seat 232. In such an implementation, countersunk aperture 360 may be configured to inhibit rotation of lock 244 when head 354 is received within aperture 360. For example, head 354 may have a hexagon outer circumferential surface, whereas the countersunk hole has corresponding hexagon interior sides. As a result, nut 362 may be rotated to raise or lower (pivot) seat 232.

In some implementations, lock 244 may “engage” shelf tab 240 in other fashions. For example, in some implementations, countersunk aperture 360 may be replaced with an internally threaded bore, wherein lock 244 is threaded through the internally threaded bore of shelf tab 240 and into the internally threaded bore 346 of seat 232, wherein the head 354 resides above shelf tab 240. In some implementations, countersunk aperture 360 may be replaced with an internally threaded bore, wherein lock 244 (in the form of the illustrated threaded bolt) is inverted with threaded shaft portion 356 threaded through seat 232 and into the internally threaded bore of tab 240, with head 354 residing below seat 232 and supporting seat 232.

In some implementations, bore 346 may be unthreaded and larger than the diameter of threaded shaft portion 356 but smaller than the internal diameter of nut 362. In such an implementation, nut 362 may be threaded onto the end of threaded portion 356, below seat 232, to support seat 232 in the shelf position. Nut 362 may be threaded onto threaded shaft portion 356 above leveling tab 236 so as to rest upon leveling tab 236 when seat 232 is in the shelf position shown in FIG. 4). In some implementations, leveling tab 236 may include an opening through which portions of threaded shaft portion 356 extend or are received, depending upon the position of nut 362 axially along threaded shaft portion 356. In such an implementation, relative rotation of the nut 362 and/or lock 244 may adjust the levelness of seat 232 in the seat position.

In some implementations, lock 244 may be configured to snap or otherwise releasably connect to shelf tab 240 to retain in the shelf position shown in FIG. 8. In the illustrated example, lock 44 is dual-purpose in that the same lock 244 retain seat 232 in both the seat position and the shelf position. Lock 244 is configured to be detached from seat 32 and reconnected, joining seat 32 to either leveling tab 236 when seat 232 is in the seat position or shelf tab 240 when seat 232 is in the shelf position. In other implementations, separate locks or separate fasteners may be employed. For example, a first lock 244 may be used when seat 232 is to be secured in the seat position shown in FIG. 8 and a second different lock 244 may be used when seat 232 is to be secured in the shelf position shown in FIG. 8.

To further move tree stand 220 to the collapsed or folded state, post 228 is pivoted about axis 250 in the direction indicated by arrow 58 shown in FIG. 4. This results in post 228 being close to parallel or parallel with platform 24. In the example illustrated, platform portion 300 of platform 224 is provided with an opening 366 configured to receive leveling tab 236 when post 228 has been pivoted to the folded position shown in FIG. 8. As result, post 228 may be positioned in closer proximity and parallel or near parallel to platform 224.

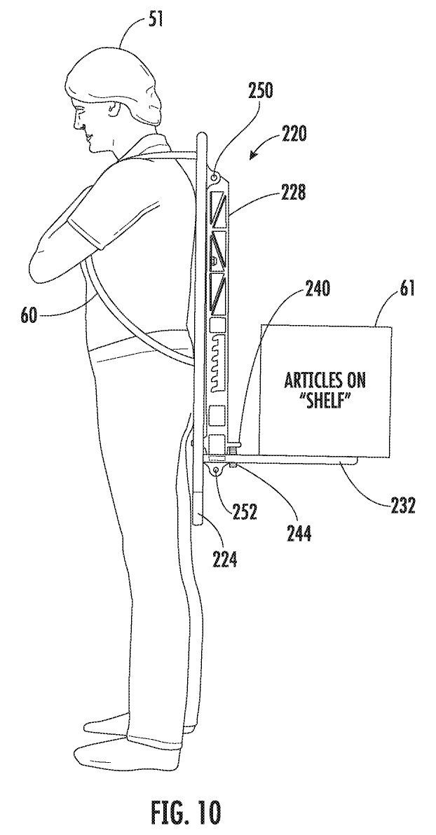

FIG. 10 illustrates tree stand 220 in the collapsed or folded state while being transported by a person 51. As shown by FIG. 10, when in the collapsed or folded state, platform 224 forms a back backing, wherein post 228 extends substantially down the center of platform 224 with platform 224 sandwiched between post 228 and the back of person 51. Seat 232 projects outwardly from post 228 and from platform 224 to serve as a shelf.

As shown by FIG. 10, tree stand 220 may additionally include a shoulder strap 60 connectable at opposite ends to at least one of platform 224 and/or post 228 to facilitate carrying of tree stand 220 in a fashion similar to a backpack. As shown by FIG. 10 articles 61 may rest upon seat 232. In some implementations, additional securement mechanisms may be provided on seat 232, such as cleats, projections or the like, to facilitate securement of such articles on the shelf provided by seat 232 with bungee cords, straps and the like.

Each of the above described tree stands comprises a platform, a post pivotably connected to the platform, a leveling tab extending from the post, and a shelf tab extending from the post. The post is pivotable between an upright position relative to the platform and a folded position along the platform. The seat is pivotably connected to the post and is pivotable between a seat position projecting from a first side of the post and a shelf position projecting from a second side of the post opposite the first side. The seat is supported from below by the leveling tab in the seat position and vertically hangs from the shelf tab in the shelf position.

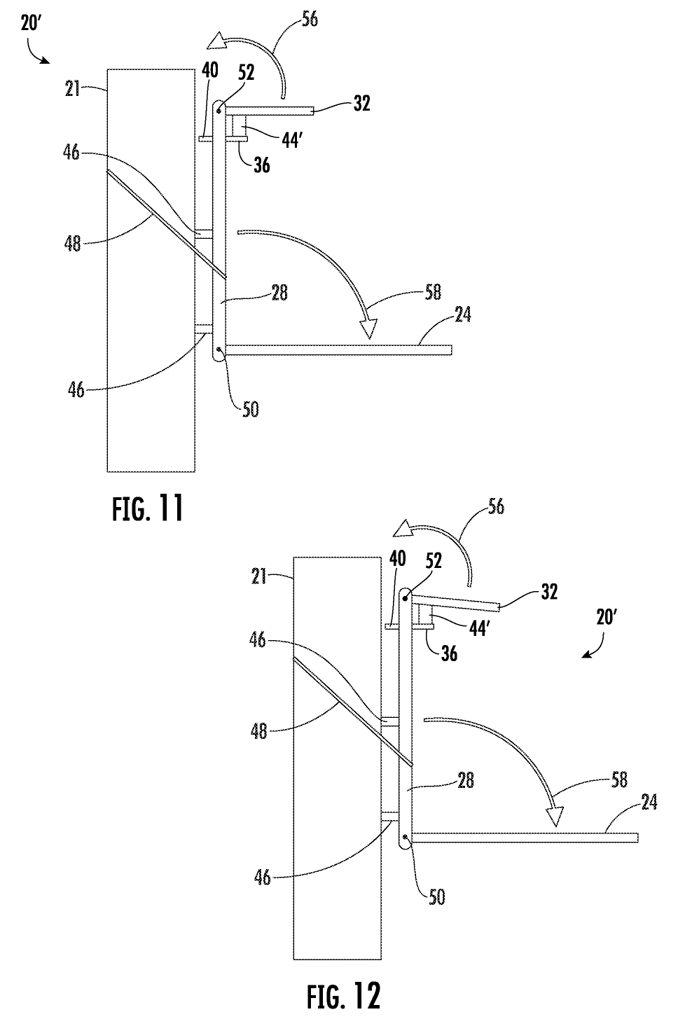

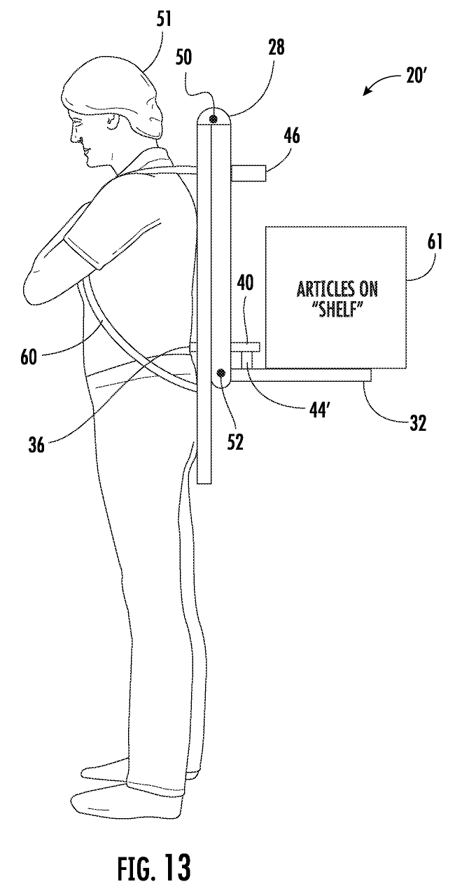

FIGS. 11-13 schematically illustrate an example tree stand 20’. having a combined or dual-purpose seat leveler-suspension coupler (SLSC) 44’. Those components of tree stand 20’ which correspond to components of tree stand 20 described above are numbered similarly. SLSC 44’ is dual purposes in that it both supports seat 32 at a selected tilt angle in the seat position (two angular positions of which are shown in FIGS. 11 and 12) and supports (vertically hangs) seat 32 from shelf tab 40 when seat 32 is in the shelf position (shown in FIG. 13).

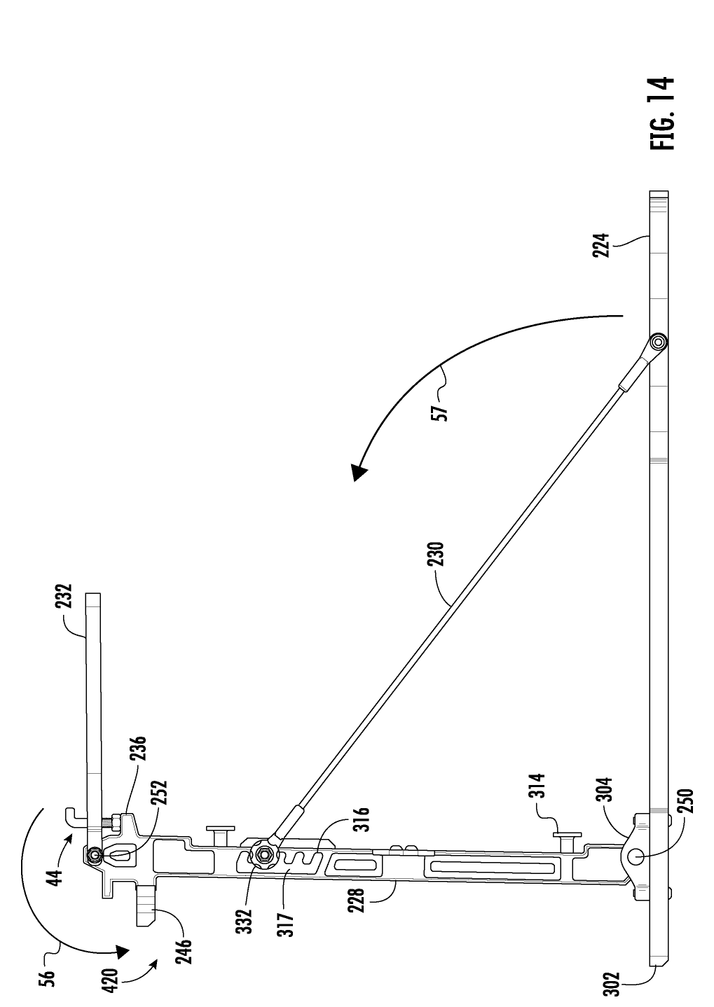

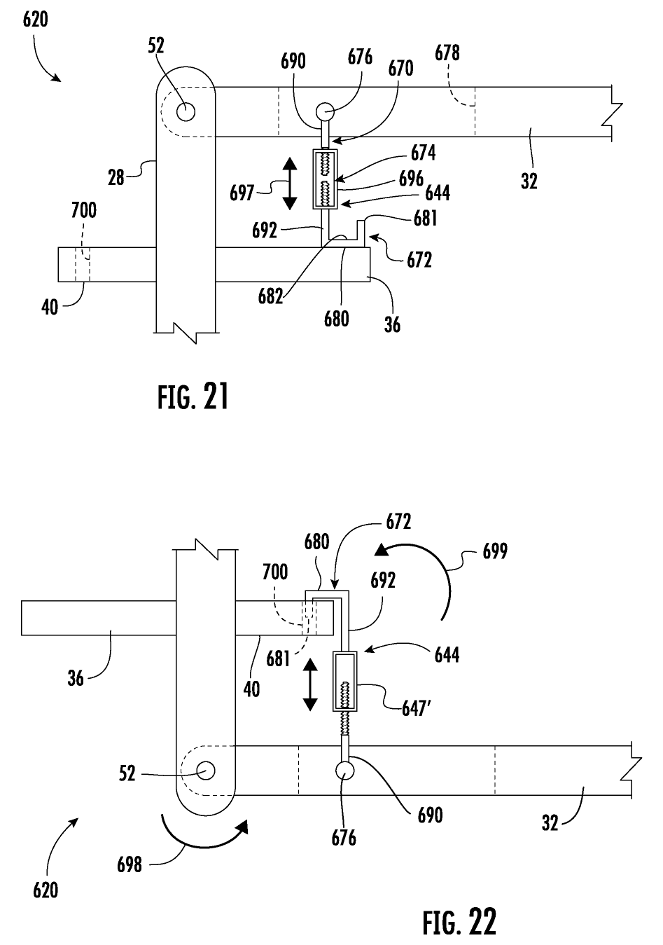

Seat leveling shelf lock 44 and seat leveling shelf lock 244 described above are examples of the combined dual-purpose SLSC 44’ of tree stand 20’. FIGS. 14-22 illustrate other examples of a combined dual-purpose SLSC. FIGS. 14-20 illustrate an example tree stand 420 with an example SLSC 444. FIGS. 21 and 22 illustrate an example tree stand 620 with an example SLSC 644.

FIGS. 14-17 illustrate an example tree stand 420 in an in-use state, a state during which tree stand 420 may be positioned against or along a tree. As with stand 220, tree stand 420 facilitates easier transport of the tree stand and additional gear. Tree stand 420 is collapsible or foldable to a state such that the tree stand may be carried along a person’s back using shoulder straps, similar to a backpack. Tree stand 420 is foldable in a fashion such that the seat of the tree stand may serve as a shelf for supporting the additional gear when the tree stand is folded and carried along the person’s back. Tree stand 420 utilizes a combined or dual-purpose SLSC 444 that controls the orientation of the seat to accommodate personal preferences or to accommodate mounting of the stand to non-vertical (tilted) portions of the tree. The dual-purpose SLSC locks or retains the seat in a shelf position or orientation when the tree stand is folded and being transported. In addition to SLSC 444, tree stand 420 comprises platform 224, post 228, strut cables 230, seat 232, leveling tab 236, and shelf tab 440. Platform 224, post 228, strut cables 230, seat 232 and self-leveling tab 236 are each described above with respect to tree stand 220.

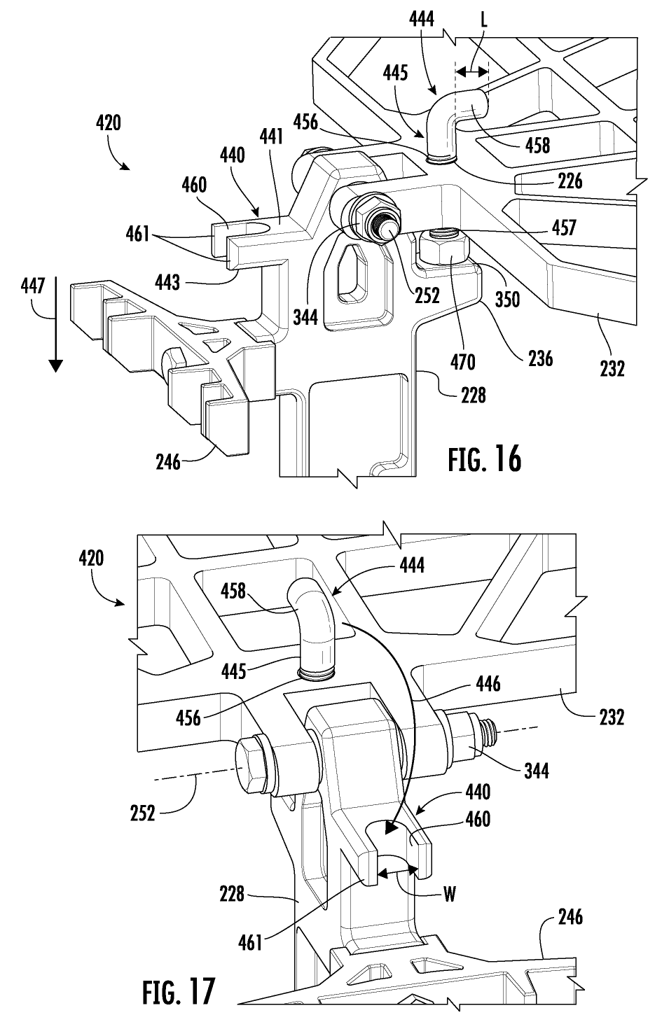

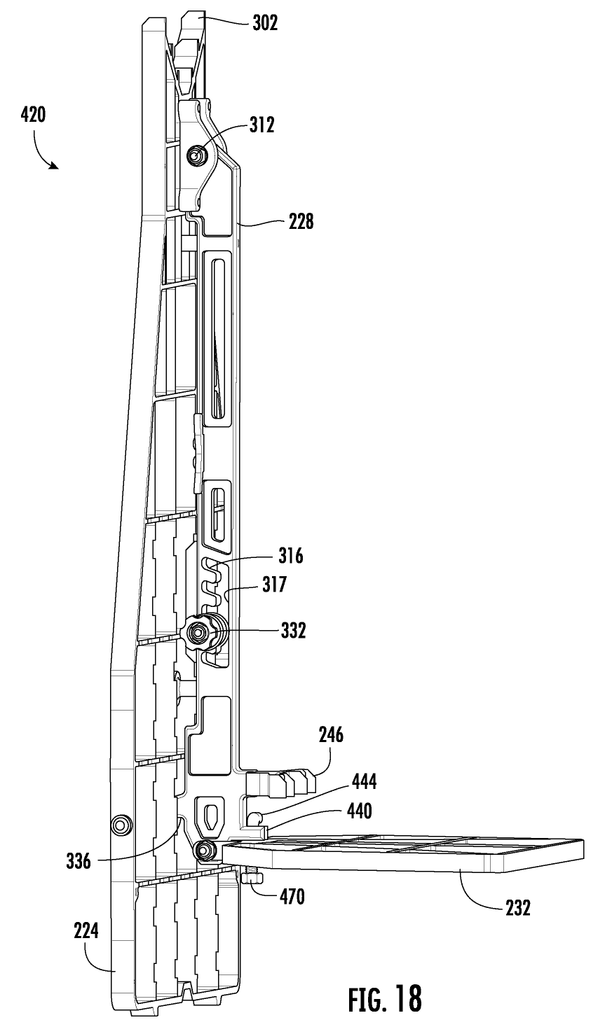

As shown by FIGS. 16 and 17, shelf tab 440 is similar to shelf tab 240 except that shelf tab 440 comprises an elongate opening or slot 460 extending from an end of shelf tab 440 most distal post 228. Slot 460 extends from a top face 441 to a bottom face 443. Slot 460 extends between two spaced prongs 461 and extends rearwardly from post 228, in a direction away from leveling tab 236. Slot 460 has a width and is located so as to receive SLSC 444 after seat 332 has been pivoted about axis 252 (as indicated by arrow 446 in FIG. 17) to the shelf position shown in FIGS. 18-20. Although top face 441 and bottom face 443 are illustrated as being generally horizontal, perpendicular to the longitudinal axis of post 228, in other implementations, one or both of faces 441443 may alternatively be angled relative to post 228. For example, bottom face 443 may be angled or sloped in the direction indicated by arrow 447, towards a location where platform 224 extends from post 228. Such anchoring may assist in retaining engagement of SLSC 444 on face 443 when SLSC 444 is vertically hanging seat 232 in the shelf position. In other implementations, shelf tab 440 may omit slot 460 where SLSC 444 is instead located so as to extend along an outermost side of tab 440 (rather than through a slot or other opening) when vertically hanging seat 232 from shelf tab 440 in the seat position.

SLSC 444 comprises a cylindrical linear shaft portion 445 and catch portion 458. Linear shaft portion 445 has an outer threaded portion 456 and a lower end portion 457. Outer threaded portion 456 is threaded through the internally threaded bore 226 in seat 232. Lower end portion 457 is located on a first side of seat 232 and has an axial end configured to abut or engage a top surface 350 of leveling tab 236 when seat 232 is in the seat position as shown in FIG. 16. In some implementations, lower end portion 457 may be coupled to a foot providing a larger surface area for bearing against the top surface 350 of leveling tab 236.

Catch portion 458 extends from linear shaft portion 445 in a direction nonparallel to the longitudinal axis of the linear portion of shaft 445. Catch portion 458 is configured to pass through slot 460 when seat 232 is pivoted about axis 252 to the shelf position. Linear shaft portion 445 and catch portion 458 have a diameter or width less than the width W of slot 460. Catch 458 has a length L sufficient so as to extend at least partially across face 443 when seat 232 is in the shelf position, after catch portion 458 has passed through slot 460 and after catch portion 458 has been rotated so as to extend perpendicular to the length of slot 460.

In the example illustrated, the inner shaft portion 445 and catch portion 458 are integrally formed as part of a single unitary body with catch portion 458 bending approximately 90 degrees from linear shaft portion 445. For example, SLSC 444 may comprise a threaded bolt having a linear providing shaft portion 445 and an angled or bent head or end portion providing catch portion 458.. In other implementations, catch portion 458 may comprise an extension member that is welded, fuse, bonded or otherwise secured to linear shaft portion 445 so as to extend nonparallel to the longitudinal axis of linear shaft portion 445.

In the example illustrated, SLSC 444 further comprises an optional threaded nut 470 threaded onto and about the sides of lower end portion 457. In some implementations the nut 470 may alternatively abut the top surface 350 of leveling tab 236. Nut 470 provides a small degree of adjustment to the tilt of seat 232. In other implementations, the nut 470 may be threaded up against and into frictional engagement with the bottom of seat 232 (as seen in FIG. 16) to assist in securing SLSC 444 and maintaining seat 232 at a selected tilt angle. In some implementations, nut 470 may be omitted.

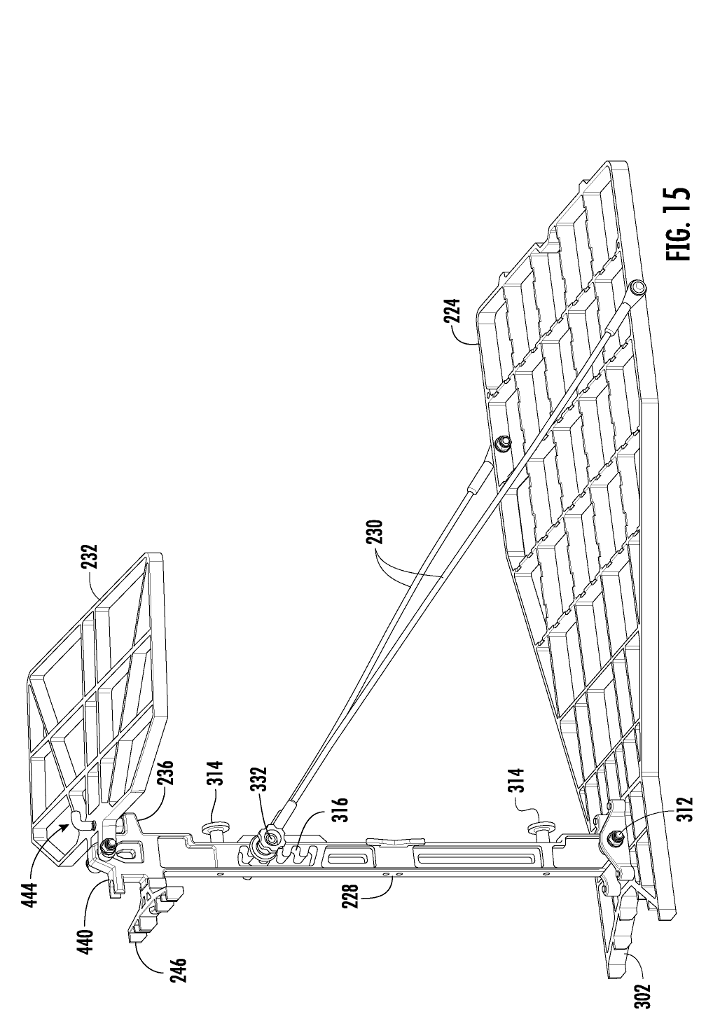

FIGS. 18-20 illustrate tree stand 420 in a collapsed or folded state. To move tree stand 420 from the in-use state shown in FIGS. 14 and 15 to the collapsed or folded state shown in FIG. 18, seat 232 is pivoted about axis 252 in the direction indicated by arrow 56 shown in FIG. 14. Seat 232 is pivoted to a position such that linear shaft portion passes vertically through slot 460 from a first side of shelf tab 440 with catch portion 458 residing on an opposite side of shelf tab 440. Platform is pivoted about pivot axis 250 in the direction indicated by arrow 57 such that platform 224 is substantially parallel to and extends along the longitudinal axis of post 228. Thereafter, the entirety tree stand 420 is inverted to the position shown in FIG. 18. Alternatively, post 228 may pivoted about that the next and opposite to that indicated by arrow 57 prior to the full tree stand being inverted 180 degrees to the position shown in FIG. 18.

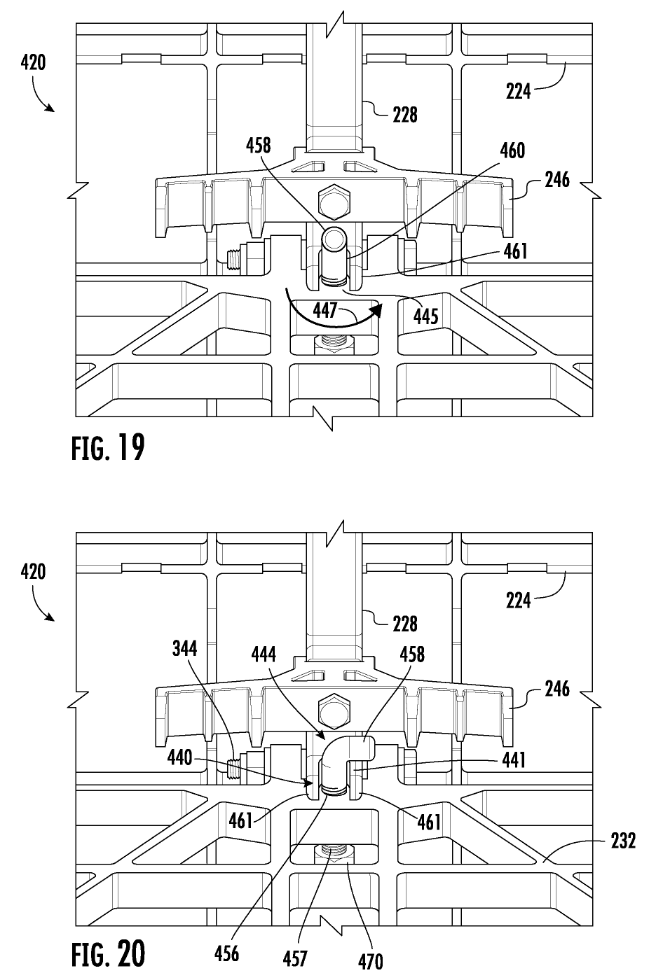

As indicated by arrow 477 in FIG. 19, catch portion 458 is rotated about the longitudinal axis of linear portion 445 so as to extend over the now top surface 443 of shelf tab 440, over one of prongs 461 as shown in FIG. 20. As a result, catch portion 458 engages one of prongs 461 to vertically hang or suspend seat 232 from and below shelf tab 440. In some implementations, one of prongs 461 may be omitted.

When tree stand 420 is to be returned to the in use state or position shown in FIGS. 14 and 15, catch portion 458 is once again rotated such that the longitudinal axis of catch portion 458 is aligned with slot 460, permitting catch portion 45A to pass through slot 460 as seat 232 is once again rotated about pivot axis 252 of her in a direction opposite to that indicated by arrow 56 in FIG. 14) to the seat position. Catch portion 252 may be further used as a lever for rotating SLSC 244 to adjust the length of SLSC 444 extending between seat 232 and leveling tab 236 so as to adjust the tilt angle of seat 232 in the seat position. Platform 224 may likewise be pivoted about its pivot axis 250 (in a direction opposite to the direction indicated by arrow 57 in FIG. 14) to return platform 224 to a horizontal or substantially horizontal orientation, generally perpendicular to post 228 for use of tree stand 420.

FIGS. 21 and 22 schematically illustrates portions of an example tree stand 620. Tree stand 620 is similar to tree stand 20 except that tree stand 620 comprises a combined dual-purpose SLSC 644 in place of the combined dual-purpose SLSC provided by seat leveling shelf lock 44. Those remaining components of tree stand 620 which correspond to components of tree stand 20 (or tree stand 20’) are numbered similarly and/or are shown above with respect to FIGS. 1-2 or FIGS. 11-12.

SLSC 644 comprises a screw adjustable support member having a first end pivotably coupled to seat 32 and a second end configured to engage leveling tab 36 when seat 32 is in the seat position shown in FIG. 21 and to engage shelf tab 40 when seat 32 is in the shelf position shown in FIG. 22. SLSC 644 comprises leg 670, catch 672 and length adjustment mechanism 674 . Leg 670 is pivotally connected to seat 32 for rotation about a pivot axis 676 . Pivot axis 676 is located such that SLSC 644 may be pivoted through a central opening 678 in seat 32 between the two position shown in FIG. 21 and 22. In some implementations, seat 32 has a transverse width (in a direction parallel to pivot axis 676) , wherein opening 678 located equidistantly from the transverse sides of seat 32 , in alignment with post 28 such that SLSC 644 is also an transverse alignment with both of tabs 36 and 40 . In some implementations, opening 678 may comprise elongate slot or opening formed in seat 32. In some implementations, seat 32 may comprise an open celled grate (similar to seat 232), wherein the open celled grate includes the elongate opening 678 having a length and width sized for the passage of SLSC 644 therethrough between the two positions.

Catch 672 extends from leg 670 and is configured to engage tabs 36 and 40 when seat 32 is in the seat and shelf positions, respectively. The example illustrated catch 672 comprises a hook having a bottom face 680 configured to bear against the top surface of leveling tab 36 when seat 32 is in the seat position and a top face 682 configured to abut surface 684 of shelf tab 40 when seat 32 is in the shelf position. In the example illustrated, catch 672 further comprises a bent end 681 configured to hook into our project into an opening 700 and shelf tab 40 when seat 32 is in the shelf position shown in FIG. 22. In other implementations, the bent end 681 and the opening 700 may be omitted. In some implementations, catch 672 may have other shapes for catching upon or engaging tabs 36 and 40.

In the example illustrated, leg 670 is configured to facilitate adjustment of its length. Leg 670 comprises a first portion 690 pivotably coupled to seat 32 and a second portion 692 connected to catch 672. Portions 690 and 692 are joined by cooperating inner and outer threads such that rotation results in lateral translation to adjust a length of leg 670. FIG. 21 illustrates one example of length adjustment mechanism 674, wherein length adjustment mechanism 674 comprises a turnbuckle mechanism having a central body 696 with threaded end fittings with opposing thread directions, wherein the threaded end fittings receive externally threaded lengths of portion 690 and 692. Rotation of the central body 696 draws together or pushes apart the externally threaded lengths (depending on the direction of rotation) to adjust a length of leg 670.

FIG. 22 illustrates length adjustment mechanism 674’, wherein one of portion 690, 692 comprises an internally threaded bore that receives an externally threaded portion of the other of portion 690 and 692 such that portion 692 may be rotated to achieve linear translation and adjust a length of leg 670. In the example illustrated, portion 692 is illustrated as having the internally threaded bore into which portion 690 is threaded. In other implementations, portion 690 may alternatively comprise the internally threaded bore into which externally threaded lengths of portion 692 may be threaded.

As indicated by arrow 697 in FIG. 21, the length of leg 670 may be adjusted in either direction to adjust the tilt angle of seat 32 when seat 32 is in the seat position. As indicated by arrow 698 in FIG. 22, tree stand 620 may be inverted and seat 32 may be pivoted about pivot axis 52 to the shelf position. As indicated by arrows 697 in FIG. 22, the length of leg 670 may be adjusted such that catch 672 may be pivoted in the direction indicated by arrow 699 so as to reside and rest upon surface 684 of shelf tab 40 (with bent end portion 681 received within opening 700, when provided), suspending and vertically hanging seat 32 from shelf tab 40.

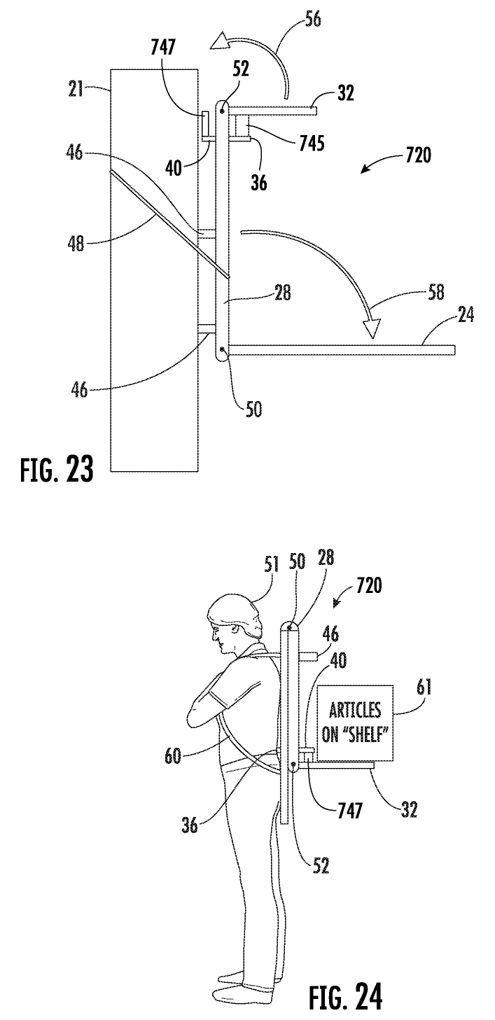

FIGS. 23 and 24 schematically illustrate an example tree stand 720 in an in use tree hanging state shown in FIG. 23 and a folded transporting shelf state shown in FIG. 24. Tree stand 720 is similar to tree stand 20’ described above except that tree stand 720 comprises separate components to support the seat in the seat position and to support the shelf position. In particular, tree’s and 720 comprises seat leveler 745 and suspension coupler 747 in place of the combined dual-purpose leveler-suspension coupler 44’. Those remaining components of tree stand 720 which correspond to components of tree stand 20’ are numbered similarly and/or are shown and described above with respect to tree stand 20’ or three stand 20 .

The seat leveler 745 extends from either the seat 32 or the leveling tab 36 and has an adjustable length to adjust the angle at which the seat 32 extends from the post 28 (the tilt of the seat away from the post 28). In some implementations, the seat leveler 745 may comprise a threaded shaft which is threaded through or into a threaded bore in the seat 32 and/or leveling tab 36, wherein rotation of the shaft adjust a length of the shaft extending between the leveling tab 36 and the seat 32 to adjust an angle of the seat 32. In some implementations, the seat leveler 745 may comprise a leg extending from one of the seat and the leveling tab and having a foot or hook which bears against a face of the other of the seat and leveling tab 36, wherein the leg has an adjustable length.

The suspension coupler 747 extends from one of the seat 32 and the shelf tab 40, wherein the suspension coupler 747 spaces and supports the seat 32 over and above the shelf tab 40 when the seat 32 is in the shelf position shown in FIG. 24. The suspension coupler 747 suspends or vertically hangs the seat 32 in a cantilevered state from the post 28, below and outwardly beyond the shelf tab 40. In some implementations, the suspension coupler 747 comprise an arm having a foot or hook which bears against or engages a face of the seat (such as a lower face of the seat) when the seat is in the shelf position. In some implementations, the suspension coupler 747 comprises a shaft having a bent end, wherein the shaft is rotatably supported by one of the seat and the shelf tab such that rotation of the shaft rotates the bent end to a position at which the bent end bears against or engages a face of the seat (such as a lower face of the seat) when the seat 32 is in the shelf position to vertically hang the seat 32 from the shelf tab 40 in the shelf position.

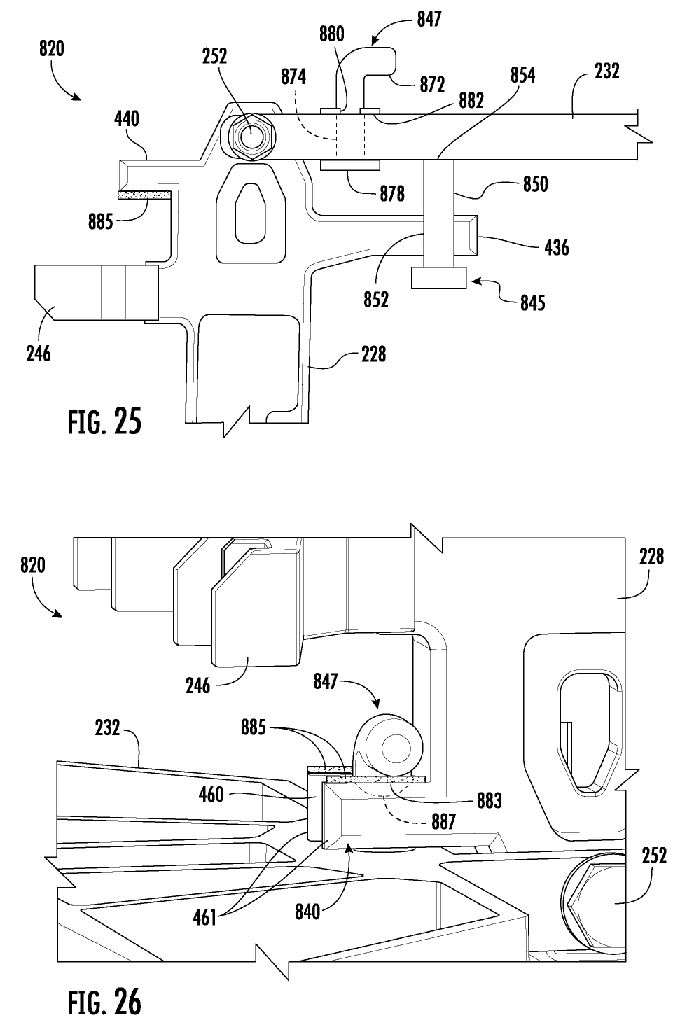

FIGS. 25 and 26 illustrate portions of an example tree stand 820. Tree stand 820 is similar to tree stand 420 described above except that tree stand 720 comprises separate components to support the seat 232 in the seat position shown in FIG. 25 and to support the seat 32 in the shelf position shown in FIG. 26. In particular, tree stand 720 comprises seat leveler 845 and suspension coupler 847 in place of the combined dual-purpose leveler-suspension coupler 444. Those remaining components of tree stand 820 which correspond to components of tree stand 20’ are numbered similarly and/or are shown and described above with respect to tree stand 420.

Seat leveler 845 comprises an externally threaded shaft 850 threaded through an internally threaded bore 852 in leveling tab 436. Shaft 850 has an axial end 854 configured to a bot and support a lower face of seat 232 when seat 232 is in the seat position shown in FIG. 25. In some implementations, shaft 850 may support a foot, plate or other structure at its axial end for engaging seat 232. In the example illustrated, see seat leveler 845 comprises a bolt. Rotation of seat lever 845 Lindley translates shaft 850 to adjust a length of shaft 850 extending between leveling tab 436 and seat 232 to adjust a tilt angle of seat 232. In some implementations, the axial end 854 of shaft 850 may be threaded into an internally threaded bore provided in seat 232 for vertically securing seat 232 when in the seat position, wherein the shaft 850 may be unthreaded from seat 232 when seats 232 is to be moved to the shelf position shown in FIG. 26..

Suspension coupler 847 is carried by seat 232 and is configured to engage shelf tab 440 when seat 232 is in the shelf position shown in FIG. 26. Suspension coupler 847 comprises shaft 870 and catch 872. Shaft 870 passes through and is rotatable within a bore 874 within seat 232. Shaft 870 terminates at a head 878 which is larger than bore 874 such that coupler 847 may support seat 232 in the shelf position. Head 870 may comprise a rivet head, or other head permanently formed as part of shaft 870 or may comprise a not threaded onto an end of shaft 870. Shaft 870 is located so as to be aligned with slot 460 and shelf 440 such that shaft 870 may pass between the prongs 461 of shelf tab 440 when seat 232 is pivoted about axis 252 to the shelf position in FIG. 26.

Catch 872 extends at an angle, nonparallel to, the longitudinal axis of shaft 870 on opposite end of shaft 870 has head 878. Catch 872 is configured so as to be movable through slot 460 in a first angular orientation and so as to extend at least partially across at least one of prongs 461 and a second different angular orientation (shown in FIG. 26). As a result, seat 232 may be pivoted about axis 252 from the seat position shown in FIG. 25 to the shelf position shown in FIG. 26, the entire tree stand 820 may be inverted, and shaft 870 may be rotated to extend catch 872 over and above at least one of prongs 461 two vertically hang or suspend seat 232 from shelf tab 440.

In some implementations, shaft 870 and catch 872 are integrally formed as part of a single unitary body. For example, coupler 847 may comprise a cylindrical shaft 870 having an end that is bent or deformed to form catch 872. In some implementations, coupler 847 may comprise a bolt providing the shaft 870 which has a bent end forming catch 872, the bolt also providing the head 878. In some implementations, the bolt may be externally threaded such that it may be threaded into an internally threaded bore 874, where head 878 at the end of the bolt may be provided or may be omitted.

In the example illustrated, suspension coupler 847 may comprise additional structures two assists in maintaining its positioning with respect to seat 232. For example, suspension coupler 847 may comprise an annular groove 880 which receives a washer 882 which is also larger than the bore 874 so as to retain coupler 847. In other implementations, shaft 870 may comprise external threads which are threaded into internal threads along the interior bore 874. In implementation with such threads, head 878 may be omitted. In some implementations, shaft 870 may be sized to provide frictional resistance with respect to the interior of bore 874 to inhibit axial movement of shaft 870 through bore 874. In other implementations, other arrangements may be provided to resist axial movement of shaft 870 through a long bore 874. In yet other implementations, shaft 870 may be freely movable through bore 874 along its longitudinal axis, wherein a person must lift catch 872 to position catch 872 over one of prongs 461 when seat 232 is in the shelf position shown in FIG. 26.

FIG. 26 illustrates suspension coupler 847 after seat 232 has been pivoted to the shelf position, after shaft and catch 872 have passed through slot 460, and after shaft 870 and catch 872 have been rotated to position catch 872 above at least one of prongs 461. In the example illustrated, surface 883 of prongs 461 may be further modified to assist in inhibiting accidental rotation of catch 872 to a position where catch 872 is aligned with slot 460 and may pass through slot 460. In the example illustrated, surface 883 may support or be coated with a high friction layer 885 formed from a material having a higher coefficient of friction than that of the remainder of shelf tab 440 ceramic, high-strength polymer or metal. For example, the layer 885 may form a rubber rubber-like material. In some implementations, surface 883 may comprise a detent or notch 887 (shown in broken lines) into which catch 872 may rest. In other implementations, layers 885 or notch 887 may be omitted.

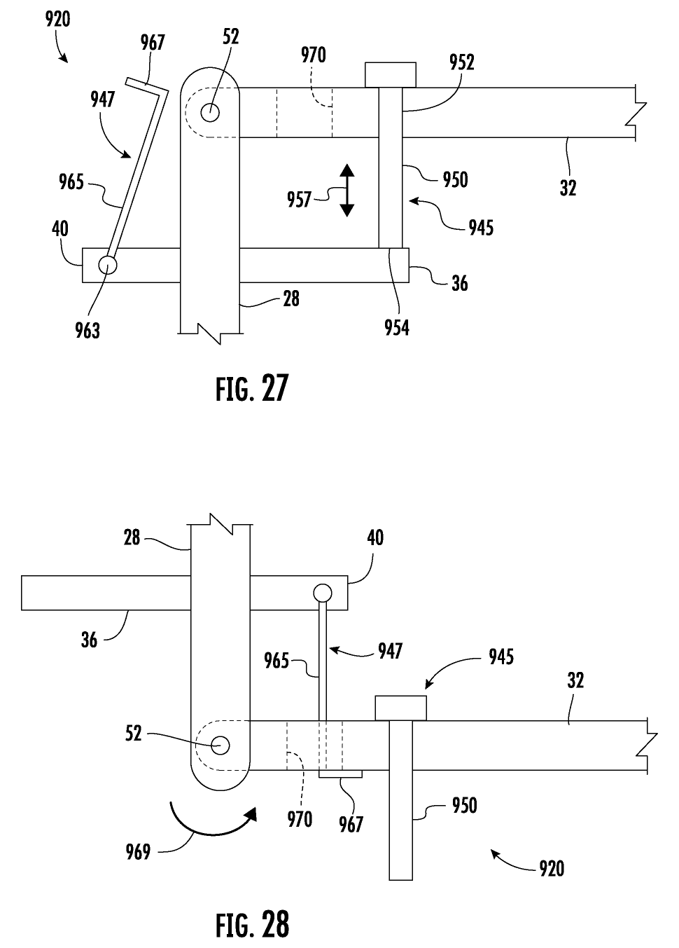

FIGS. 27 and 28 schematically illustrate portions of an example tree stand 920. Tree stand 920 is similar to tree stand 720 except that 945 and suspension coupler 947. Those remaining components of tree stand 920 which correspond to components of tree stand 720 are numbered similarly and/or are described above and shown in the figures depicting tree stand 720.

Seat leveler 945 comprises a threaded shaft 950 threaded through a threaded bore 952. Shaft 950 has an axial end 954 which engages seat tab 36. In the example illustrated, axial end 954 abuts a top face of leveling tab 36 when seat 32 is in the seat position shown in FIG. 27. In other implementations, axial end 954 may be externally threaded and may be threaded into an internally threaded bore provided in seat tab 36. Rotation of shaft 950 translates shaft 950 through bore 952 and relative to seat 32 in the direction indicated by arrows 957 to adjust a length of shaft 950 extending between a bottom of seat 32 and leveling tab 36.

Suspension coupler 947 is pivotally coupled to shelf 40 for pivotal movement about axis 963. Coupler 947 comprises a leg 965 and a catch 967. As shown by FIG. 28, after seat 32 has been rotated about axis 52 (as indicated by arrow 969) to the shelf position, suspension coupler 947 may be rotated such that catch 967 engages or catches upon a lower surface or other portions of seat 32 to vertically hang and suspend seat 32 from shelf tab 40. In one example implementation, seat 32 may comprise an opening 970 through which catch 967 may pass and may be repositioned to catch upon a bottom surface of seat 32.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one him in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first,” “second”, “third” and so on in the claims merely distinguish different elements and, unless otherwise stated, are not to be specifically associated with a particular order or particular numbering of elements in the disclosure.

What is claimed is:

1. A tree stand comprising:
a platform;
a post pivotably connected to the platform, the post being pivotable between an upright position relative to the platform and a folded position along the platform;
a leveling tab extending from the post;
a shelf tab extending from the post; and
a seat pivotably connected to the post, the seat being pivotable between a seat position projecting from a first side of the post and a shelf position projecting from a second side of the post opposite the first side,
wherein the seat is supported from below by the leveling tab in the seat position and vertically hangs from the shelf tab in the shelf position.

2. The tree stand of claim 1, wherein seat, in the seat position, is supported from below by the leveling tab at one of a plurality of user selectable angles relative to the post.

3. The tree stand of claim 2, wherein the seat comprises an internally threaded bore, the tree stand further comprising an externally threaded member threaded through the internally threaded bore and engaging the leveling tab to serve as a seat leveler, wherein the externally threaded member is rotatable to support the seat at one of the plurality of user selectable angles relative to the post.

4. The tree stand of claim 3, wherein the externally threaded member also serves as a suspension coupler and wherein the seat, in the shelf position, is vertically hung below the shelf tab at least in part by the externally threaded member serving as the suspension coupler.

5. The tree stand of claim 4, wherein the shelf tab comprises a second internally threaded bore and wherein the externally threaded member threads through the second internally threaded when the seat is in the shelf position.

6. The tree stand of claim 4, wherein the shelf tab comprises a top face and a bottom face and wherein the externally threaded member overlies and rests upon the top face while extending below the bottom face when the seat is vertically hung from the shelf tab in the shelf position.

7. The tree stand of claim 6, wherein the externally threaded member passes through the shelf tab when the seat is vertically hung from the shelf tab in the shelf position.

8. The tree stand of claim 7, wherein the externally threaded member is rotatable within the internally threaded bore between a first position such that the externally threaded member may be moved through the shelf tab and a second position configured to overlie and rest upon the top face when the seat is in the shelf position.

9. The tree stand of claim 8, wherein the externally threaded member comprises a first portion comprising threads that thread through the internally threaded bore and a second portion extending nonparallel to the first portion, the second portion resting upon the top face when the seat is in the shelf position.

10. The tree stand of claim 3 further comprising a suspension coupler configured to vertically hang the seat from the shelf tab when the seat is in the shelf position.

11. The tree stand of claim 10, wherein the suspension coupler releasably engages the shelf tab.

12. The tree stand of claim 11, wherein the suspension coupler engages and disengages the shelf tab through rotation of the suspension coupler.

13. The tree stand of claim 12, wherein the suspension coupler releasably engages the seat.

14. The tree stand of claim 10, wherein the suspension coupler releasably engages the seat.

15. The tree stand of claim 14, wherein the suspension coupler engages and disengages the seat through rotation of suspension coupler.

16. The tree stand of claim 10, wherein the suspension coupler is pivotably supported by one of the seat and the shelf tab and wherein the suspension coupler pivots between a first state hanging the seat from the shelf tab and a disconnected state such that the seat may be pivoted to the seat position.

17. The tree stand of claim 1 further comprising:
a seat leveler extending between the seat and the leveling tab, the seat leveler supporting the seat in the seat position; and
a suspension coupler extending between the seat and the shelf tab, the suspension coupler suspending the seat in the shelf position.

18. The tree stand of claim 17, wherein the seat leveler is configured to support the seat in the seat position at one of a plurality of user selectable angles relative to the post.

19. The tree stand of claim 1 further comprising a combined dual-purpose seat leveler-suspension coupler configured to (1) extend between the seat and the leveling tab to support the seat in the seat position and serve as a seat leveler and (2) extend between the seat and the shelf tab to suspend the seat in the shelf position and serve as a suspension coupler.

20. The tree stand of claim 19, wherein the combined dual-purpose seat-leveler-suspension coupler is carried by the seat.
